(19) United States
(12) Patent Application Publication
(10) Pub. No.: US 2009/0151596 A1
(43) Pub. Date: Jun. 18, 2009

(54) Fastload rail carrier for motor vehicles, freight and passengers

(76) Inventor: William Harvey Sproat, Cartersville, GA (US)

Correspondence Address: William Harvey Sproat, 192 Ridgeview Trail SE, Cartersville, GA, 30120, US

(21) Appl. No.: 12/316,356

(22) Filed: Dec. 10, 2008

Related U.S. Application Data
(60) Provisional application No. 61/007,401, filed on Dec. 12, 2007.

(51) Int. Cl. B61D 15/00; B61D 17/26; B61B 1/02; B65G 67/02

(52) U.S. Cl. 105/159; 105/413; 104/29; 414/809

(57) ABSTRACT

This invention is a rail grade load/unload rail carrier with primary vertical load bearing sub-assemblies positioned above the carrier body floor. Carrier body sub-assemblies are vertical columns with stay cables attached to rail carrier bar joist sides. The design features carrier body floor elevation slightly above rail grade, and detachable rail wheel bogies outside the carrier body, to enable motor vehicle rail grade loading/unloading. Rail wheel bogie variants may be used for rail gage adaptation. Further, loaded motor vehicles provide rail carrier motive power; drive wheels protruding downward through carrier floor apertures to bear on rail flanking traction strips. Traction strips connect to a vehicle staging platform which has; integral rails, rail line connection, and highway access. Autonomous motor vehicle carrier translation along rails and across the staging area, negates need for conventional rail terminal handling facilities. Alternatively, the staging platform provides a maneuvering surface for portable lifting equipment to handle non-motorized cargo, including intermodal freight containers and passenger enclosures.

### CROSS REFERENCE TO RELATED APPLICATIONS

This application is based on provisional application Ser. No. 61/007,401, filed on Dec. 12, 2007.

### STATEMENT REGARDING FEDERALLY SPONSORED RESEARCH OR DEVELOPMENT

Not Applicable

### DESCRIPTION OF ATTACHED APPENDIX

Disclosure of Invention: Fast-load rail carrier system for motor vehicles, freight and passengers April 2008 Sproat

### U.S. Patent Documents

| | | | |
|---|---|---|---|
| 4,385,857 | May 1983 | Willetts | 410/5.3 |
| 4,452,147 | June 1984 | Jwuc | 105/4.2 |
| 4,547,107 | October 1985 | Krause | 410/5.8 |
| 4,597,337 | July 1986 | Willetts | 105/4.1 |
| 4,665,834 | May 1987 | van Iperson | 105/4.1 |
| 4,669,391 | June 1987 | Wickes, et al. | 105/4.3 |
| 4,838,744 | August 1987 | Baker | 105/4.1 |
| 4,766,818 | August 1988 | Wickes, et at. | 105/4.3 |
| 4,838,744 | June 1989 | Bakka, et at. | 410/53 |
| 4,841,872 | June 1989 | WIckes, et al. | 104/4.3 |
| 4,907,514 | March 1990 | Wickes, et al. | 105/4.3 |
| 4,922,832 | May 1990 | Lineard, et al. | 105/4.2 |
| 504,066 | August 1991 | Wickes, et al. | 105/4.3 |
| 5,537,931 | July 1996 | Donkin | 105/159 |
| 589,433 | April 1999 | Wickes | 105/4.2 |
| 6,050,197 | April 2000 | Wickes | 105/4.2 |
| 6,095,055 | August 2000 | Lohr, et al. | 105/4.2 |
| 6,736,071 | May 2004 | Engle | 105/238.1 |

### BACKGROUND OF THE INVENTION

This invention relates generally to the field of intermodal transport and more specifically to a fast-load rail carrier design for motor vehicles freight and passengers. The invention offers a means to facilitate highway/rail intermodal transit conversion without rail terminal infrastructure.

Historically, freight rail transit has provided significant advantage over highway use in terms of cost per ton mile. However, just-in-time-inventory concepts and inherent routing flexibility have driven favor to highways. Now, the highway transit mode is encountering diminishing appeal from rapidly rising fuel costs, increasing accident exposure, and traffic delays.

Consequently, there is renewed interest in rail transit for economy, reliability, and safety. Railroads first accommodated this trend with “piggyback” semi-trailer rail transport. Now there is rapid growth in containerized intermodal freight transport by rail. Both “piggyback” and intermodal approaches require significant rail terminal infrastructure,

An innovative concept to avert rail terminal requirements is a hybrid freight trailer which operates on highways and is transitioned to rail by lifting the trailer with a relatively small device to position it on rail wheel bogies. But this approach remains bound to mechanized infrastructure and trailers must have chassis draft load capacity to operate in trains. This encumbers the trailer with excessive dead weight on highways, thus lowering payload capacity. The need remains for overcoming these obstacles to highway/rail transit mode conversion.

### DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims, and as a representative basis for teaching one skilled in the art to employ the present invention in virtually any appropriately detailed system, structure or manner. While the invention has been described in connection with a preferred embodiment, it is not intended to limit the scope of the invention to the particular form set forth, but on the contrary, it is intended to cover such alternatives, modifications, and equivalents as may be included within the spirit and scope of the invention defined by the appended claims.

The invention, fast-load rail carrier system for motor vehicles, freight and passengers, henceforth referred to as rail carrier system, is disclosed in detail by the following figure descriptions and discussion which serve to exemplify the form, component interface features, and function of the invention.

FIG. 1. illustrates three major elements of the invention:
I. A rail grade motor vehicle staging platform 15 with integral rails 14 contiguous with rail flanking traction strips 16, also at rail grade;
II. A longitudinally and laterally symmetrical rail carrier body with primary vertical load bearing sub-assemblies consisting of columns 10 which support stay cables 11 and side positioned bar joists 12; and
III. Rail wheel bogies 13 attached to the rail carrier body by coupling with the rail carrier body draft sill illustrated in FIG. 4.

These three major elements combine common civil engineering structure; column/stay cables, bar joists and highway pavement, with standard rolling stock rail wheel bogies to enable intermodal transit mode conversion without conventional rail terminal infrastructure. The intermodal transit mode conversion stage is a paved or suitably surfaced area, connected to a rail line and featuring highway access. Rail flanking traction strips are pavement or suitable bearing material placed on, and affixed to, rail tie ends.

FIG. 2A. illustrates bar joist components consisting of: paired angle upper cap 20 bar diagonal 21 and paired angle lower cap 22. An end view of a cylindrical tubing rail carrier body cross-member is shown, captured by a bar bend 24 and the lower bar joist cap. The stay cable 25 is attached to the cross-member with a cable end fixture 26. The cable opposing end, with a loop and swaged collar, is secured by a pin 27 captured by a bar bend and upper bar joist cap. Stay cable pre-tension is accomplished by rotating the cross-member, counterclockwise in this view, winding the cable about the cross-member outside diameter. The mirror image cable on the rail carrier opposite side is also pre-tensioned in this procedure. The cross-member is fixed to bar bends and bar joist caps when pre-tension load meets assembly standards.

FIG. 2B. illustrates the rail carrier floor 201 (floor track in this case) contiguous with the rail carrier bar joist 202, bearing on, and affixed to, a cross-member 205. From attachment to the cross member upward, the stay cable 203 is routed between bar joist upper cap angles 204, to the column apex, FIG. 1.-11. Cable tension load from the cross-member is reacted by cable tension load from the column apex to the securing pin 27 in FIG. 2.

FIG. 3. depicts the rail carrier body 30 with one of two rail wheel bogies 31 detached for carrier loading; hinged ramps 32 down, and rail carrier body auxiliary wheels 33 bearing on rail flanking traction strips 34. Auxiliary wheels carry vertical load when rail wheel bogies are detached. These wheels provide rolling capability for translation along rails in transition to the rail transit mode. In practice, detached rail wheel bogies remain at a distance from the rail carrier body to permit unobstructed motor vehicle entry.

FIG. 4A. details a side view of a loaded motor vehicle with drive wheels 45 positioned downward through rail carrier body floor apertures 46 to bear on rail flanking traction strips 47. This enables the motor vehicle to autonomously translate the rail carrier body in either direction along rail flanking traction strips, and across the intermodal transit mode conversion stage.

FIG. 4B. details a plan view of the rail carrier body draft sill 40 with end couplers attached to opposing rail wheel bogies 41. Section view A-A depicts a draft sill section consisting of multiple cables 43 in a concrete matrix 44 cast in a channel 42. Draft sill composition takes advantage of superior cable (wire rope) tensile strength for demanding rail car draft loads and very good compression (braking and coupling impulse) load properties properties of concrete. Draft sill cables, attached to coupler end fittings, are post-tensioned in a green (uncured) concrete matrix, commonly applied to reinforcement elements in concrete bridge structures.

FIG. 5. depicts, by expanded projections, a rail wheel bogie 51 fitted with a bar joist receiver 50 featuring joist receiver cavities 52 for bar joist ends 53 when the rail wheel bogie is attached to the the rail carrier body. Stay cables 54 are routed upward through apertures in the bar joist receiver cavities.

FIG. 6. illustrates side and plan views of the rail carrier body ramps 60 connected to rail carrier floor tracks 61. Ramps are hinge pinned 62 to floor tracks 61. Lift pins 63 are used for ramp raising and lowering as illustrated in FIG. 7.

FIG. 7. perspective view lower left illustrates ramps 70 down, one of two rail wheel bogies 72 detached from the rail carrier body 71. FIG. 7. perspective view lower right illustrates the same ramps 70 up and secured by the same rail wheel bogie 72 attached to the rail carrier body 71. FIG. 7. upper orthographic projections exhibit ramp lift with a lift fork 72 attached to a coupling interface 76. (As described in FIG. 7, the coupling interface is joggled to accommodate elevation differences between couplers 78 and 79.) Leftward translation of the rail carrier body with draft sill coupler 77 engages coupler 78.

In summary, the motor vehicle loading scenario characterizing the process for loading the rail carrier system proceeds as follows:
I) A pre-positioned rail carrier is located on rail flanking traction strips extending from one side of the intermodal transit conversion staging platform;
ii) One rail wheel bogie, detached from the rail carrier body, is pre-positioned on rail flanking traction strips on the opposite side of the staging platform;
iii) A motor vehicle enters the rail carrier body and seats drive wheels through floor track apertures to bear on rail flanking traction strips;
iv) Once vehicle non-drive wheels are chocked, the loaded rail carrier body is translated back across the stage, applying intrinsic vehicle motive power, to attach with its formerly detached rail wheel bogie;
v) A second rail carrier is staged in the pre-position location formerly used with the first by continued rearward translation of the fully assembled first rail carrier to couple with a second, drawing that rail carrier for staging with detachment of its rear-most rail wheel bogie from its rail carrier body (forward rail wheel bogie remaining attached), and positioning the second rail carrier body across the staging platform to opposing rail flanking traction strips;
vi) The first rail carrier then decouples from the second, proceeding forward to couple with other rail rolling stock or locomotive; and
Viii) With continued rail transit off the staging platform and rail flanking traction strips, rail carrier body auxiliary wheels are above rail tie ends and other potential obstructions along the line.

Motor vehicle intermodal transit mode conversion is one of several applications for the invention. Non-motorized cargo, such as containerized intermodal freight, can be loaded/unloaded from staging platforms with portable lifting equipment. Rail carrier floors, configured as grills, offer convenient means for anchoring throughout; accommodating various cargo shapes and dimensions. Rail borne passenger enclosures are another rail carrier application. Passenger transit on conventional railroad lines in suburban communities can be connected with urban light rail for rapid transit without major infrastructure investment. The invention, with its high strength-to-weight ratio, allows for such light rail operation.

These high strength-to-weight ratio primary vertical load bearing sub-assemblies are time proven civil engineering designs. Sub-assemblies in combination, are multiple load path, damage tolerant structure; easily inspected by visual means. Further, these sub-assemblies have fixed overall structure profiles. Selection of materials, component section thickness/placement, and doubler add-ons provide for manufacturing rail carrier bodies over a wide spectrum of load capacities with the same production tooling.

### BRIEF SUMMARY OF THE INVENTION

Objects of the invention are presented in the following exhibit, taken in connection with the accompanying drawings, wherein, by way of illustration and example, an embodiment of the present invention is disclosed.

In accordance with a preferred embodiment of the invention, there is disclosed a fast-load rail carrier for motor vehicles, freight and passengers comprised of a symmetrical rail carrier body with identical and opposed detachable rail wheel bogies at each end. Detachable rail wheel bogies and primary vertical load bearing sub-assemblies, consisting of carrier side column/stayed cable and bar joists above the carrier floor to enable loading/unloading from rail grade. Column loads bear downward on bar joists near rail wheel bogies, transferring cable tension loads from bar joist spans. Bar joists in-turn, bear vertical loads downward on rail wheel bogies.

In accordance with a preferred embodiment of this invention, there is disclosed a fast-load rail carrier transit mode staging area; a paved or suitably surfaced motor vehicle maneuvering platform with integral rails, highway access and rail connection. Further, rail flanking traction strips, contiguous to the staging area, serve as highway/rail transit mode conversion sites.

In accordance with a preferred embodiment of this invention, there is disclosed a transit mode conversion process for fast-load rail carrier loading of motor vehicles, freight and passenger enclosures. Motor vehicle loading entails: maneuvering on the above described staging area, rail carrier body entry from rail grade via hinged integral ramps, positioning vehicle drive wheels through carrier floor apertures to bear on rail flanking traction strips, motor vehicle powered autonomous translation of the carrier body along rails, enabling attachment with the rail wheel bogie formerly detached from the carrier body for loading, and further translation along rails to couple with identical rail carriers, other rail borne rolling stock, and locomotives. Reverse of the above process applies to unloading.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1. is a perspective view of the fast-load rail carrier consisting of cable stay columns 10 stay cables 11 rail carrier body bar joist sides 12 detachable rail wheel bogies 13 positioned on rails 14 extending from a motor vehicle maneuvering platform 15 with rail flanking traction strips 16 extending from the platform.

FIG. 2A. details a side view of the rail carrier body bar joist: upper cap 20 bar diagonal 21 and lower cap 22 underfloor cylindrical tube cross-member 23 captured by a bar joist bend 24 with a stay cable 25 fixed to the cylindrical tube cross-member by a cable end fitting 26.

FIG. 2B. details plan and section views of the rail carrier floor 201 (tracks in most floor configurations) affixed to a cylindrical tube cross-member 205 vertically supported by a stay cable 203 routed through bar joist 202 upper cap angles 204.

FIG. 3. illustrates the rail carrier body 30 one of two rail wheel bogies 31 detached from the rail carrier body, hinged ramps 32 down, auxiliary wheels 33 bearing on rail flanking traction strips 34.

FIG. 4A. details a side view of the loaded rail carrier with motor vehicle drive wheels 45 protruding downward through carrier floor apertures 46 to bear on rail flanking traction strips 47.

FIG. 4B. details the rail carrier body center draft sill 40 attached to rail wheel bogies 41: the draft sill comprised of a channel 42 multiple cables 43 in a cast concrete matrix 44.

FIG. 5. depicts, by expanded orthographic projections, a rail wheel bogie 51 fitted with a bar joist receiver 50 exhibiting symmetrically positioned bar joist receiver cavities 52 bar joist ends 53 engaged with the the bar joist receiver; and stay cables 54 routed through bar joist receiver cavity upper surface apertures.

FIG. 6. illustrates side and plan views of rail carrier body integral ramps 60 in the down position for rail grade loading. Ramps are connected to carrier floor tracks 61 by hinge pins 62 and ramp lift pins 63 to lift and stow for rail transit.

FIG. 7. perspective view lower left shows ramps 70 down, a rail wheel bogie 72 detached from the rail carrier body 71. FIG. 7. perspective view lower right illustrates the same ramps 70 up; the same rail wheel bogie 72 attached to the rail carrier body 71. FIG. 7. expanded projection views upper, detail the bar joist receiver 73 bearing on and pinned to a rail wheel bogie. A joggled rail coupler interface 76 with knuckle couplers at two elevations 78 and 79 is also pinned to the rail wheel bogie. A ramp lift fork 74, fixed to the coupler interface 76 engages ramp lift pins 75 during rail carrier body draft sill 77 attachment to the coupler interface.

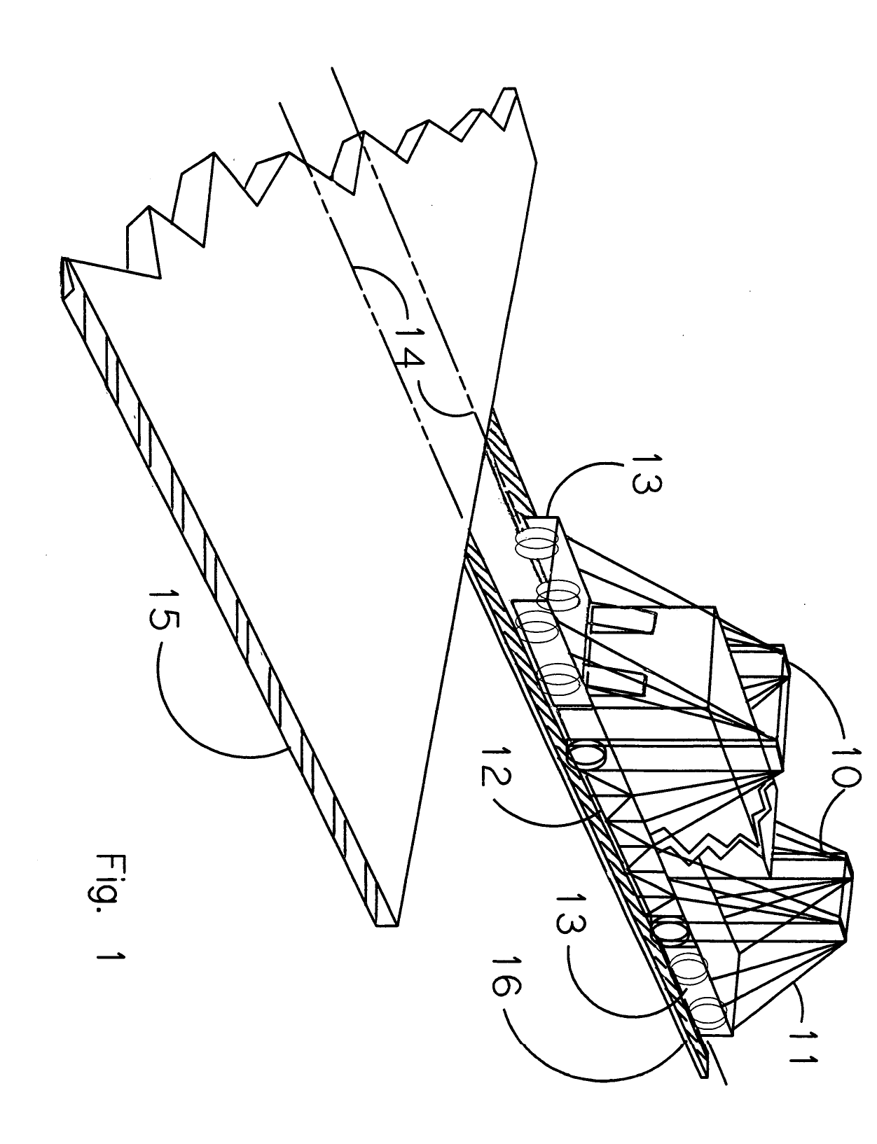

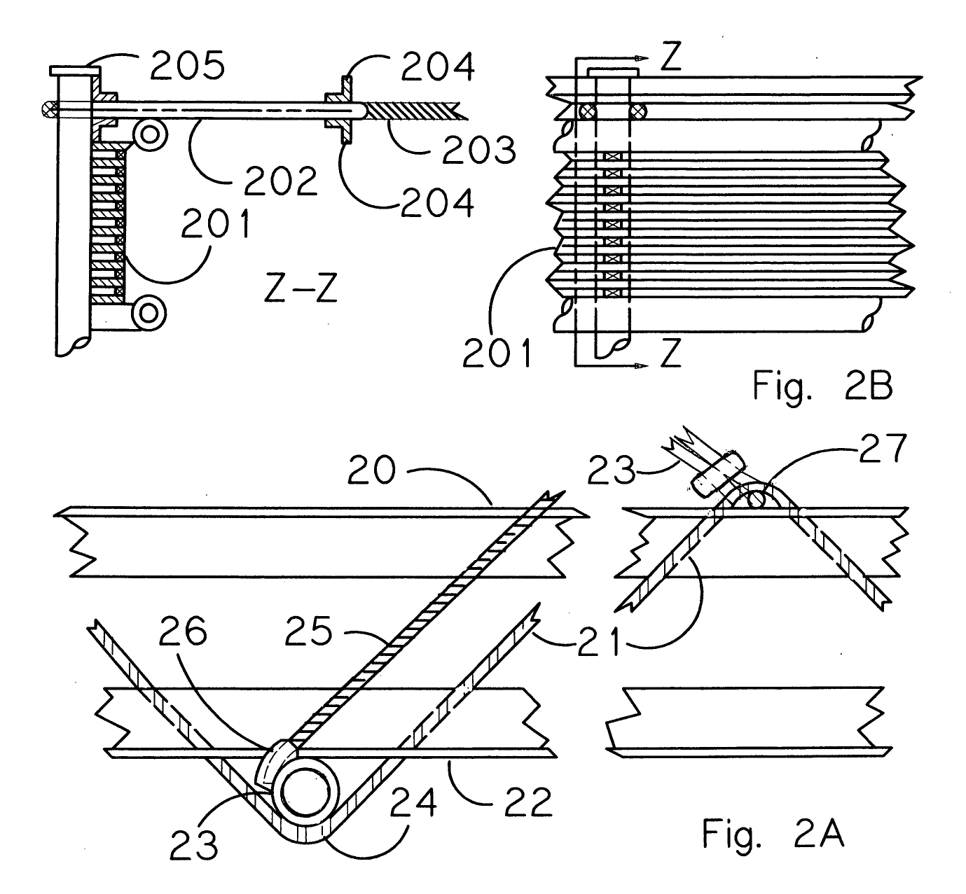

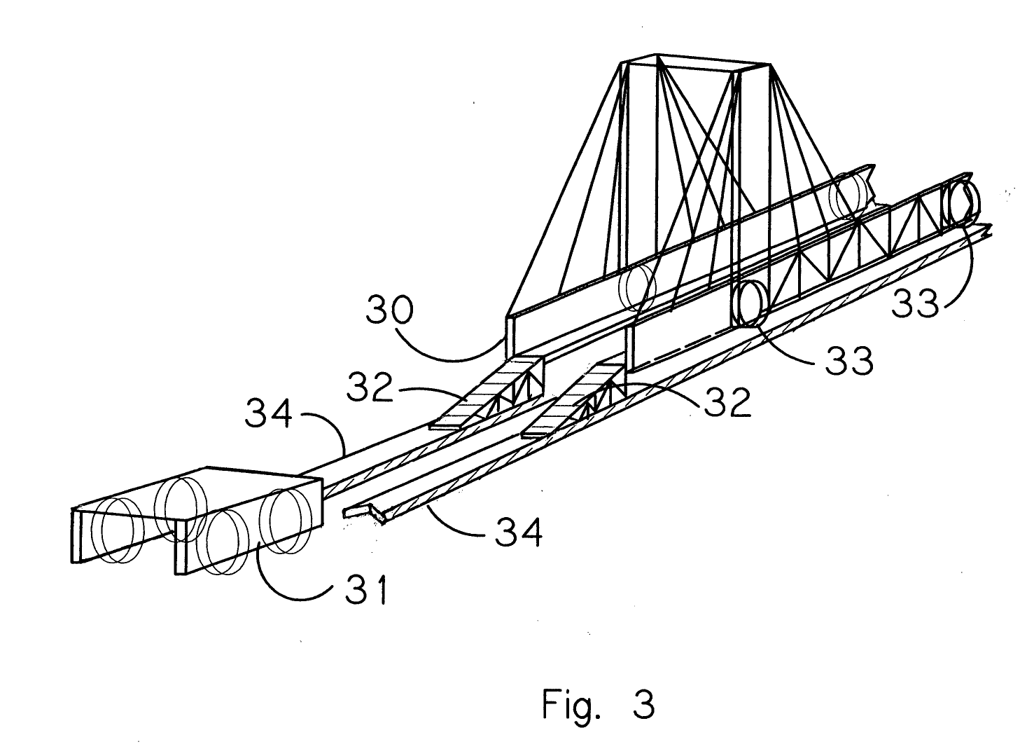

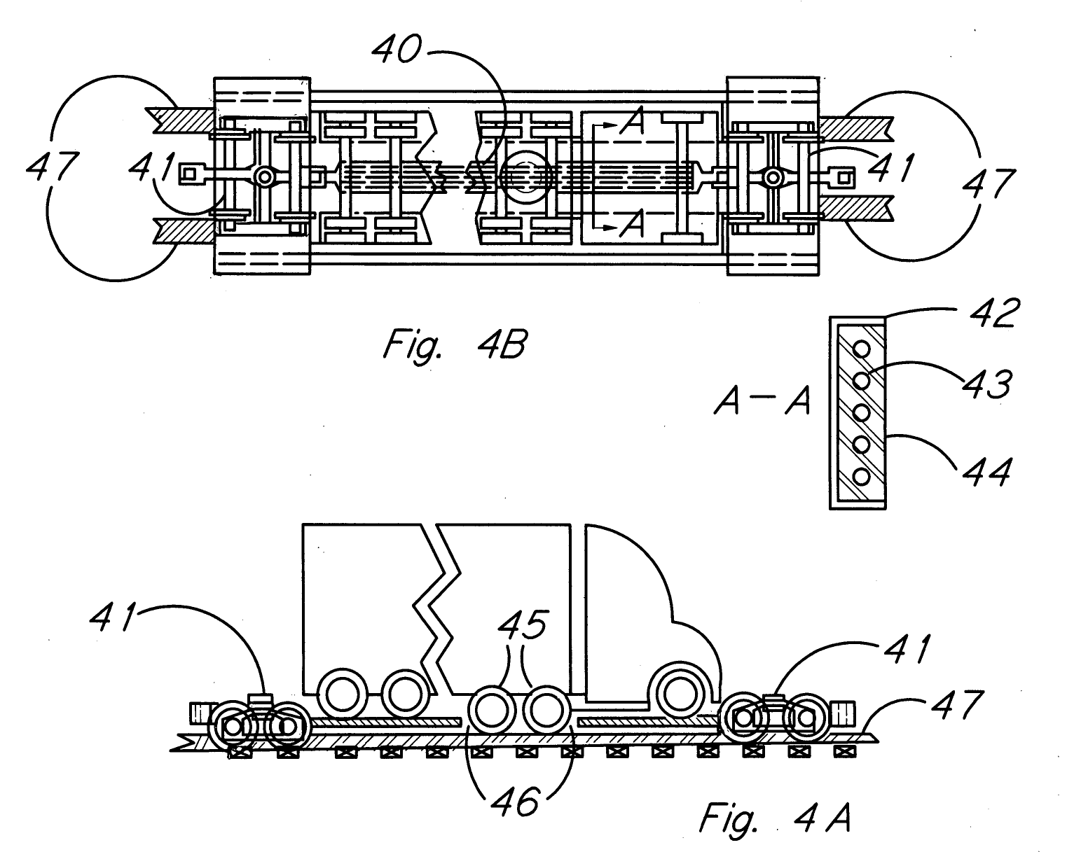

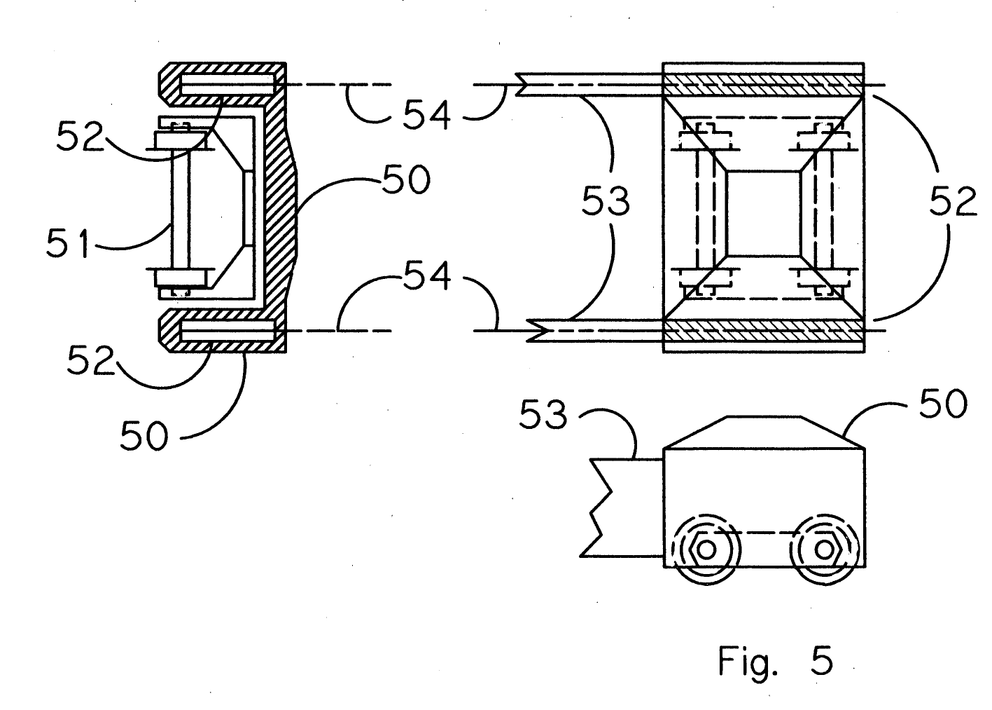

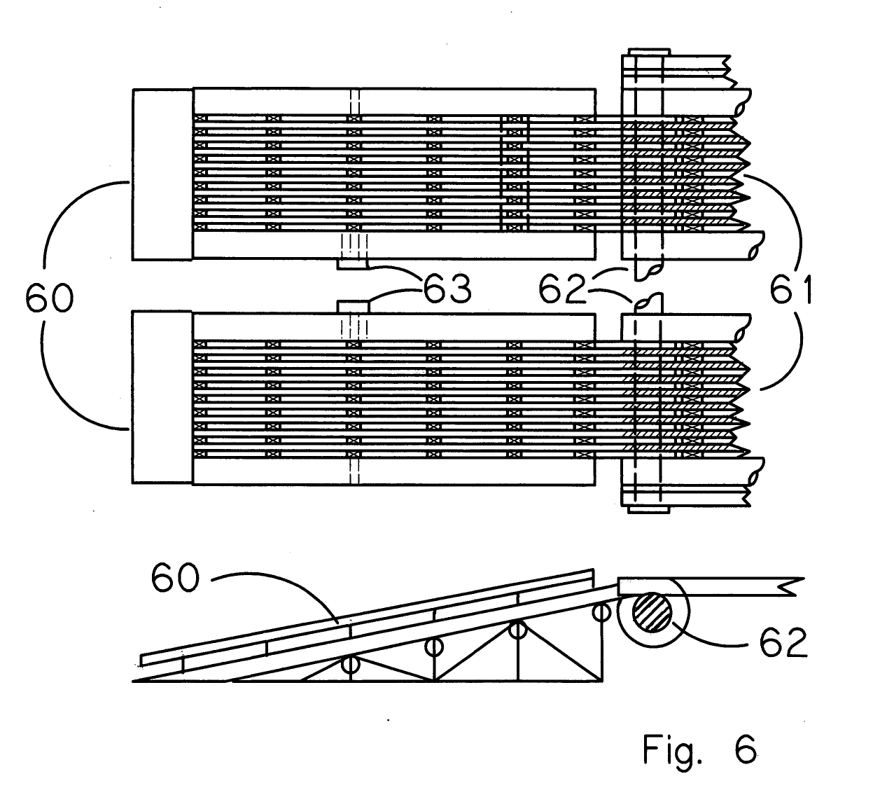

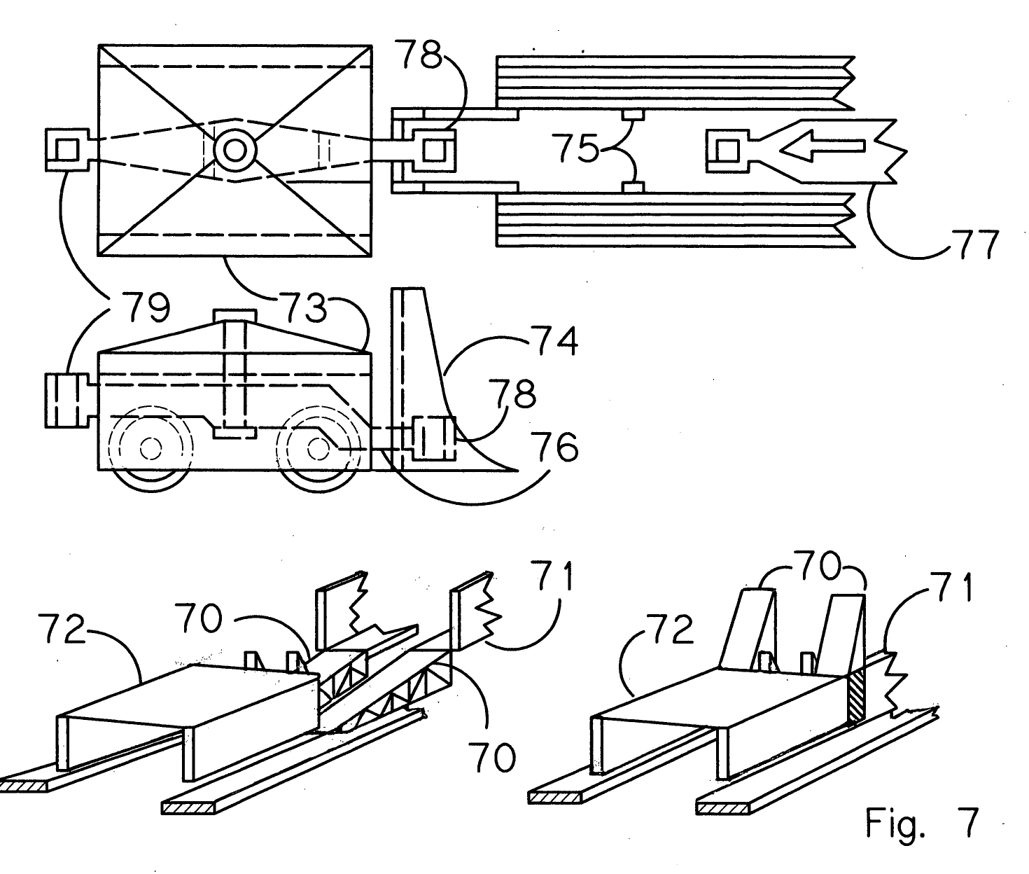

What is claimed is:

1. A rail grade fast-load rail carrier system for motor vehicles, freight and passengers comprised of: a symmetrical rail carrier body with detachable rail wheel bogies at both ends of said rail carrier, and an intermodal transit mode conversion staging platform with contiguous rail flanking motor vehicle traction strips;

2. Said rail carrier body consisting of two primary vertical load bearing sub-assemblies which are: columns with stay cables and bar joists on opposite sides of said rail carrier body; said sub-assemblies positioned above the rail carrier body floor or axially configured floor tracks, permitting said floor tracks or floor elevation near rail grade, thus enabling motor vehicle loading and unloading at rail grade;

3. Said primary vertical load bearing sub-assemblies exhibiting multiple load path, damage tolerant structure, readily inspected by visual means without structural disassembly;

4. Said detachable rail wheel bogies, external to said rail carrier body, providing a means to position said rail carrier body floor near rail grade for loading and unloading without fixed ramps or mechanized rail terminal facilities;

5. Said rail wheel bogies fitted with rail wheel/axle assemblies of optional select gages, interfacing with common said carrier bodies;

6. Said primary vertical load bearing sub-assemblies exhibiting configurations which offer flexible design options to a spectrum of load capacities without change in overall structure profile;

7. Said column/stayed cable and bar joist sub-assemblies offering; superior strength-to weight ratios, economical materials use, and light rail compatibility;

8. Said rail carrier body featuring mutiple underfloor cylindrical tubing cross-members spanning between, and affixed to said bar joists, serving both as vertical load bearing structure, integral with said rail carrier body, and functioning as devices to tension said stay cables by winding in rotation before fixing to said bar joists;

9. A longitudinal centerline draft sill affixed to said rail carrier body cross-members, composed of: multiple cables embedded in a cast concrete matrix formed in a channel, providing draft tensile load, and braking /coupling impulse compressive load transfer;

10. A rail/highway intermodal transit mode conversion staging platform for fast-load/unload of motor vehicles comprising: a paved or suitably surfaced platform with integral rails for ground or highway motor vehicle maneuvering, connection with a rail line, highway access, and rail flanking traction strips at rail grade, contiguous with, and extending from said intermodal transit mode conversion staging platform, said traction strips extending a sufficient distance from said staging platform for rail train make-up and break-down;

11. Elements of the invention serving as adjuncts to the process of said intermodal transit mode conversion consisting of: auxiliary wheels on said rail carrier body for bearing support and translation on said traction strips when one or both said rail wheel bogies are detached, integral hinged ramps affixed to both ends of said rail carrier body, motor vehicle drive wheel apertures in said rail carrier body floor, and forks affixed to a coupling interface as a mechanism for raising and lowering said hinged ramps;

12. A process for intermodal transit mode conversion through loading said fast-load rail carrier comprising the steps of: maneuvering said motor vehicle on said intermodal transit mode conversion platform, loading said motor vehicle via said ramps from rail grade into said carrier body, one or both said rail wheel bogies detached from said rail carrier body, positioning said motor vehicle to place drive wheels through said rail carrier body floor apertures to bear on said rail flanking traction strips, chocking said motor vehicle non-drive wheels, motor vehicle driven autonomous translation of said rail carrier body along said rail flanking traction strips to couple said rail wheel bogies with said rail carrier body, and additional translation along said rail flanking traction strips to couple with and stage additional rail carrier(s) and/or train make-up;

13. A process for unloading said fast-load rail carrier system for motor vehicles comprising reversal of the sequence exhibited in claim 12; and

14. A process for loading/unloading non-motorized cargo on/from said rail carrier on said intermodal transit mode conversion stage with portable lifting equipment.
